(19) United States
(12) Patent Application Publication
(10) Pub. No.: US 2018/0149334 A1
(43) Pub. Date: May 31, 2018

(54) HEADLIGHT AND METHOD FOR OPERATING THE HEADLIGHT

(71) Applicant: Automotive Lighting Reutlingen GmbH, Reutlingen (DE)

(72) Inventors: Bernd Muehlbauer, Ostfildern (DE); Markus Kindler, Stuttgart (DE); Achim Bathe, Reutlingen (DE)

(73) Assignee: Automotive Lighting Reutlingen GmbH, Reutlingen (DE)

(21) Appl. No.: 15/810,596

(22) Filed: Nov. 13, 2017

(30) Foreign Application Priority Data
Nov. 28, 2016 (DE) 102016122874.5

(51) Int. Cl. F21S 8/10

(52) U.S. Cl. CPC F21S 48/335; F21S 48/325

(57) ABSTRACT

A headlight for a motor vehicle having a headlight housing with a light module arranged therein for producing a desired light distribution, wherein the headlight housing comprises an air-inlet opening and an air-outlet opening for air to flow through the headlight housing.

### CROSS-REFERENCE TO RELATED APPLICATIONS

The present application claims priority to and all the benefits of German Patent Application No. 10 2016 122 874.5, filed on Nov. 28, 2016, which is hereby expressly incorporated herein by reference in its entirety.

### BACKGROUND OF THE INVENTION

### 1. Field of the Invention

The invention relates to a headlight, as well as to a method for operating the headlight.

### 2. Description of the Related Art

It is well-known that condensation causes a thin water film to settle on the interior cover pane of the motor vehicle headlight. This veil visible from the outside is occasionally mistakenly considered by end customers as a defect of the headlight, which results in complaints. To avoid water condensation inside the motor vehicle headlight, the headlight is ventilated. For example, appropriate inlet and outlet openings are known from DE 197 26 328. By means of such inlet and outlet openings, it is possible to produce an air flow, which allows the motor vehicle headlight to be defrosted.

Furthermore, it is well-known that legislation enforces the development of more energy-efficient vehicles, which particularly affects the design of the front surface of the motor vehicle and thus on the flow resistance coefficient. This results in the fact that the front surface is largely sealed, for example, by means of rubber seals. Therefore, basically the same pressures are formed on a headlight housing and especially in regions accessible for ventilation openings, which means that the differential pressures required for defrosting the interior of the motor vehicle headlight are at different places of the motor vehicle headlight only minimal or difficult to predetermine. As a result, ventilation of the internal space of the headlight by means of differential pressure is made more complicated.

### SUMMARY OF THE INVENTION

It is the objective of the invention to ensure air exchange with the surrounding area when operating the vehicle (even while standing, for example, in a traffic jam). This minimizes the risk of condensation and increases the defrosting speed when condensation has already formed on the glass pane.

We propose a headlight in which a condensation-critical operating situation of the headlight can be determined. An air-conducting arrangement inside the headlight housing comprises a fan that can be operated, depending on the determined condensation-critical operating situation of the headlight, to supply fan air from the air-inlet opening to the air-outlet opening for cooling the light module.

Advantageously, by determining the condensation-critical operation and the respective operation of the fan, the risk of condensation, especially of the cover pane, is considerably reduced. In case condensation has already been formed, the defrosting speed can be greatly accelerated. Especially in park or slow driving situations, which represent a condensation-critical operating situation, it is possible to ensure an air exchange of the headlight.

A further advantage of the proposed headlight involves that the arrangement of the air-inlet and air-outlet opening can be selected in wide limits. It is no longer required to position the above-mentioned openings for the production of differential pressure. Advantageously, it is also possible to arrange the respective opening at a side of the headlight housing facing the vehicle floor.

One advantageous embodiment of the headlight is characterized in that the condensation-critical operating situation comprises a vehicle speed of 0 km/h. Advantageously, via the vehicle speed, it is possible to gather a high number of condensation-critical operating situations.

One advantageous embodiment of the headlight is characterized in that a non-condensation-critical operating situation is determined, wherein the fan is switched off, depending on the determined non-condensation-critical operating situation. As a result, an energy-efficient reduction of the risk of condensation is achieved.

One advantageous embodiment of the headlight is characterized in that the non-condensation-critical operating situation is determined when, after a time of determining the condensation-critical operating situation, a pre-determined period has expired. Thus, a simple possibility is produced for designing the headlight in an energy-efficient manner.

One advantageous embodiment of the headlight is characterized in that a suction pipe supplied to the fan comprises a passage opening, which connects in an air-conducting manner the internal space of the suction pipe with an internal space of the headlight housing. For example, if the suction pipe is blocked within the range of a filter in the region of the air-inlet opening, it is still possible to ensure circulation of air inside the headlight. During normal operation, approximately 20% of the circulated air volume consists of fresh air. This is achieved by adapting the cross-section of the suction pipe and the size of the passage opening to the internal space, as well as through the air permeability of the filter.

One advantageous embodiment of the headlight is characterized in that a discharge pipe comprises a passage opening, which connects in an air-conducting manner the internal space of the discharge pipe with an internal space of the headlight housing. For example, if the discharge pipe is blocked within the range of the discharge outlet, it is still possible to ensure circulation of air inside the headlight.

One advantageous embodiment of the headlight is characterized in that a discharge outlet of a discharge pipe is arranged to face a cover pane, which closes a light aperture of the headlight housing. As a result, warm air can advantageously rise at the inner wall of the cover pane and thus prevent or minimize effectively condensation of the pane.

A further aspect relates to a method, in which a condensation-critical operating system of the headlight is determined. An air-conducting arrangement inside the headlight housing comprises a fan that is operated, depending on the determined condensation-critical operating situation of the headlight, to supply fan air from the air-inlet opening to the air-outlet opening for cooling the light module.

### BRIEF DESCRIPTION OF THE DRAWINGS

Further characteristics, application possibilities and advantages of the invention are included in the following description of embodiments of the invention, which are shown in the figures of the drawing. For functionally equivalent variables and characteristics, the same reference numerals are used in all figures, even in different embodiments. The figures show:

FIG. 1 shows a headlight in a sectional view;

FIG. 2 shows a headlight in a sectional view; and

FIG. 3 shows a headlight in a sectional view.

### DETAILED DESCRIPTION OF THE INVENTION

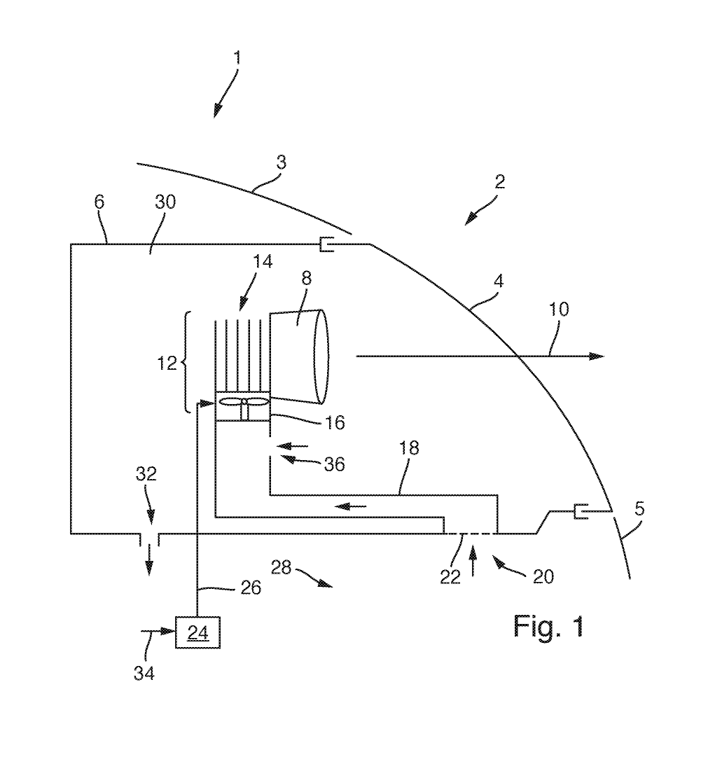

FIG. 1 shows a sectional view of a headlight 2, which has a cover pane 4 that closes a light aperture of a headlight housing 6. The headlight 2 is arranged between body parts 3 and 5 in a front section of a motor vehicle 1. Inside the headlight housing 6 a light module 8 is arranged, which emits a beam distribution 10 through the basically transparent cover pane 4 into a region in front of the motor vehicle. The light module 8 comprises at least one light source, for example, a semiconductor light source, which generated thermal energy during operation.

In the present case, a cooling arrangement 12 comprises a cooling body 14 and a fan 16. Preferably, the fan 16 is arranged inside the headlight housing 6. For example, the fan 6 comprises an electric motor and rotor blades arranged at the rotors of the electric motor. The cooling body 14 is connected in a heat-conducting manner with the light module 8. The fan 16 ensures that air circulates around the cooling ribs of the cooling body 14 to ensure that heat is dissipated from the cooling body 14 and thus from the light module 8. It is also possible to arrange the cooling body 14 and the fan 16 at a distance from the light module 8, wherein, for example, heat pipes are provided to connect the cooling body 14 with the light module 8. The heat pipes result in degrees of freedom to use the available installation space in the headlight housing.

The fan 16 is connected in an air-conducting manner through a suction pipe 18 to an air-inlet opening 20, which comprises in the present case an air filter 22. The air filter 22 can be designed in a replaceable manner. Preferably, the air-inlet opening 20 is arranged at a distance from a region, which is significantly affected by exhaust heat of a motor of the motor vehicle 1. This prevents air already heated from being supplied to the light module 8.

For example, it is certainly possible that an additional suction pipe (not shown), which is arranged outside of the headlight housing 6, is connected to the air inlet opening 20. Preferably, the opening of said suction pipe is arranged at a distance from the region, which is significantly affected by the exhaust heat of the motor.

A control device 24 operates the fan 16 via a signal 26 in such a way that air from an external space 28 is sucked in by the fan 16 and guided over the cooling body 14. Thus, heat is transported away from the light module 8 and the light module 8 is cooled. The control device 24 comprises a processing unit and a memory unit, wherein a computer program is saved on the memory unit. The computer program performs the procedural steps described here, which are carried out on the processing unit.

The air flowing past the cooling body 14 or the air flowing through the cooling body 14 is guided into an internal space 30 of the headlight housing 6. The induced air causes low pressure inside the internal space 30, which results in the fact that the air in the internal space 30 flows via an air outlet opening 32 into the external space 28 of the headlight housing 6.

The control device 24 is supplied with a vehicle speed 34. It is certainly possible to supply the control device 24 with additional variables, for example, an ambient temperature to determine a condensation-critical operating situation. Depending on the supplied variables, the control device 24 determines a condensation-critical operating situation of the headlight 2. If this condensation-critical operating situation is available, the fan 16 is forced to circulate air. Independent of the operating situation of the light module 8, the condensation-critical operating situation can result in light generation. This means that even when the light module 8 is switched off the fan is operated for determining the condensation-critical operating situation.

If the control device 24 determines that the vehicle speed 34 ranges below a threshold of, for example, 20 km/h, 10 km/h or even at 0 km/h, the fan 16 is switched on to force the circulation of air, if it is not already in operation. During its operation, the fan 16 supplies air from the air-inlet opening 20 to cool the light module 8 and past the light module to the air-outlet opening 32. The forced operation of the fan 16 during the condensation-critical operating situation considerably reduces the probability that water condensation occurs at the cover pane 4.

For example, the condensation-critical operating situation concerns the action of parking the vehicle temporarily in a parking lot. A further condensation-critical operating situation involves the action of stopping a vehicle during a traffic jam. In both condensation-critical operating situations, heat can unnecessarily enter the internal space 30 of the headlight housing 6 if the fan 16 does not force the circulation of air.

The condensation-critical operating situation is determined by a sensor, which is arranged inside the headlight housing 6 in inside the vehicle. In one embodiment, the condensation-critical operating situation exists if a temperature determined by a temperature sensor, which is arranged outside of the headlight housing 6, falls below a threshold value and a driving condition involves undercutting a vehicle speed.

The control device 24 also determines when a non-condensation-critical operating situation of the headlight 2 occurs. In the non-condensation-critical operating situation, the control device 24 releases a shutdown of the fan 16 and switches the fan 16 off. However, if the light module 8 is operated for light emission, it can be necessary to continue cooling the light module 8. Therefore, the fan 16 can only be switched off after the light module 8 has been switched off. For example, the non-condensation-critical operating situation can be determined when after establishing the condensation-critical operating situation a previously determined time period has expired. This results in a certain post-run time of the fan 16, when the vehicle is turned off for parking.

The suction pipe 18 comprises a passage opening 36, which connects an internal space of the suction pipe 18 with the internal space 30 of the headlight housing 6. The cross-section of the passage opening 36 effective for the air flow is smaller than the cross-section of the air-inlet opening 20 effective for the air flow, but still big enough that it is possible to produce an air flow from the fan 16 when the air-inlet opening 20 is unintentionally closed. An air-conducting arrangement inside the internal space 30 of the headlight comprises the fan 16 and the suction pipe 18.

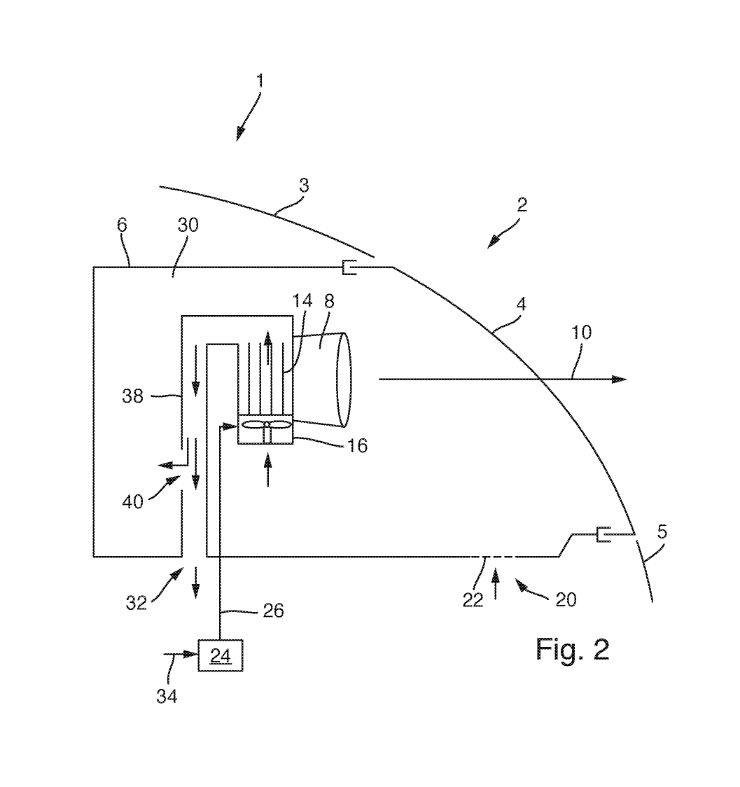

FIG. 2 shows a sectional view of a further embodiment of the headlight 2. In contrast to FIG. 1, FIG. 2 shows that air from the internal space 30 is sucked in by the fan 16, which is arranged inside the headlight 2, and guided over the cooling body 14. A discharge pipe 38, into which the air guided over the cooling body 14 can be guided to the air-outlet opening 32, is connected to the cooling body 14. The discharge pipe 38 comprises a passage opening 40, which connects in a fluid-conducting manner an internal space of the discharge pipe 38 with the internal space 30 of the headlight housing 6. The cross-section of the passage opening 40 effective for the air flow is smaller than the cross-section of the air-outlet opening 32 effective for the air flow, but still big enough that it is possible to produce an air flow by the fan 16 when the air-inlet opening 20 is unintentionally closed. An air-conducting arrangement inside the internal space 30 comprises the fan 16 and the discharge pipe 38. The fan 16 can be operated by the control device 24 in the same way as described in FIG. 1.

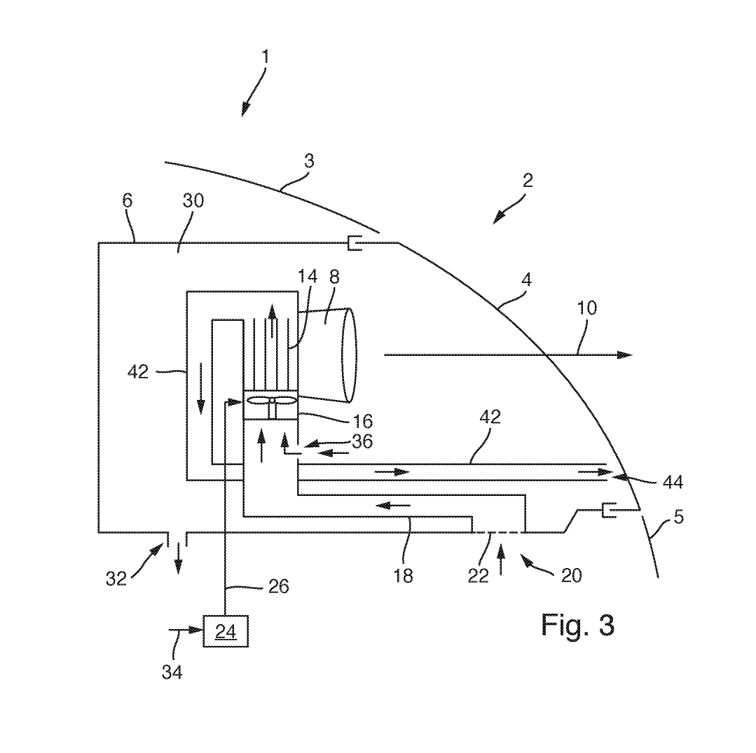

FIG. 3 shows a sectional view of a further embodiment of the headlight 2. In contrast to FIG. 1, FIG. 3 shows a further discharge pipe 42, the discharge opening 44 of which is located in a lower front section of the internal space 30. Thus, the discharge pipe 42 ends near the cover pane 4. The air discharged from the discharge opening 44 was previously heated by the heat dissipation of the light module 8 and rises along an inner wall of the cover pane 4 in the internal space 30. This ensures forced circulation of air in the region of the inner wall of the cover pane 4, which prevents or minimizes condensation of water at the inner wall of the cover pane 4. An air-conducting arrangement inside the internal space 30 comprises the suction pipe 18, the fan 16 and the discharge pipe 42. The fan 16 can be operated by the control device 24 in the same way as described in FIG. 1.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. A headlight for a motor vehicle having a headlight housing with a light module arranged therein for producing a desired light distribution, wherein the headlight housing comprises an air-inlet opening and an air-outlet opening for air to flow through the headlight housing, wherein:
a condensation-critical operating situation of the headlight can be determined, and
an air-conducting arrangement inside the headlight housing comprises a fan that can be operated, depending on the determined condensation-critical operating situation of the headlight, to supply fan air from the air-inlet opening to the air-outlet opening for cooling the light module.

2. The headlight as set forth in claim 1,
wherein the condensation-critical operating situation comprises a vehicle speed of zero km/h.

3. The headlight as set forth in claim 1,
wherein a non-condensation-critical operating situation is determined, and
wherein the fan is switched off, depending on the determined non-condensation-critical operating situation.

4. The headlight as set forth in claim 2, wherein the non-condensation-critical operating situation is determined when, after a time of determining the condensation-critical operating situation, a pre-determined period has expired.

5. The headlight as set forth in claim 1,
wherein a suction pipe comprises a passage opening, which connects in an air-conducting manner the internal space of the suction pipe with an internal space of the headlight housing.

6. The headlight as set forth in claim 1,
wherein a discharge pipe comprises a passage opening, which connects in an air-conducting manner the internal space of the discharge pipe with an internal space of the headlight housing.

7. The headlight as set forth in claim 1,
wherein an outlet opening is facing a further discharge pipe of a cover pane, which closes a light emission opening of the headlight housing.

8. A method for operating a headlight for a motor vehicle having a headlight housing with a light module arranged therein for producing a desired light distribution, wherein the headlight housing comprises an air-inlet opening and an air-outlet opening for air to flow through the headlight housing, wherein:
a condensation-critical operating situation of the headlight is determined, and
an air-conducting arrangement inside the headlight housing comprises a fan that is operated, depending on the determined condensation-critical operating situation of the headlight, to fan air from the air-inlet opening to the air-outlet opening for cooling the light module.

9. The method as set forth in claim 8 for operating the headlight, wherein the condensation-critical operating situation comprises a vehicle speed of zero km/h.

10. A control device, which is designed to perform the method as set forth in claim 8.

11. A motor vehicle comprising a headlight as set forth in claim 1.
